(19) United States
(12) Patent Application Publication
(10) Pub. No.: US 2026/0249817 A1
(43) Pub. Date: Aug. 27, 2026

(54) CLEANING DEVICE FOR VEHICLE SENSOR CAMERA LENS

(71) Applicant: DY AUTO Corporation, Asan-si (KR)

(72) Inventor: Jeong Goo Lee, Asan-si (KR)

(73) Assignee: DY AUTO Corporation, Asan-si (KR)

(21) Appl. No.: 19/550,833

(22) Filed: Feb. 26, 2026

(30) Foreign Application Priority Data
Feb. 27, 2025 (KR) 10-2025-0026018

(51) Int. Cl. B60S 1/56; B08B 3/02; B08B 5/02; B60S 1/52; B60S 1/54; G02B 27/00

(52) U.S. Cl. CPC B60S 1/56; B08B 3/02; B08B 5/02; B60S 1/52; B60S 1/54; G02B 27/0006

(57) ABSTRACT

A cleaning device for a vehicle sensor camera lens includes a sensor camera including a lens at an end thereof, a support structure including a lens through hole, through which the lens passes, and supporting the sensor camera, and a fluid passage and a spray nozzle formed on the support structure and supplying a fluid supplied from outside to the lens of the sensor camera.

### CROSS REFERENCE TO RELATED APPLICATION

This application is based on and claims priority under 35 U.S.C. §119 to Korean Patent Application No. 10-2025-0026018, filed on February 27, 2025, in the Korean Intellectual Property Office, the disclosure of which is incorporated by reference herein in its entirety.

### FIELD

The disclosure relates to a cleaning device for a vehicle camera sensor, and more particularly, to a structure of a device for cleaning a surface of a sensor camera lens installed outside a vehicle.

### BACKGROUND

Generally, vehicles are equipped on their exterior with sensor cameras for ensuring driver safety and driving convenience to perform various functions such as parking assistance, lane keeping, autonomous driving, etc. However, these sensor cameras are directly exposed to the external environment during driving such that a lens surface frequently becomes dirty due to contaminants such as dust, rainwater, snow, and mud. In the case where contaminants accumulate on a lens, the quality of a camera image is degraded, impairing the accurate operation of a vehicle system. To address this issue, some vehicles employ cleaning devices such as washer fluid spray devices or wipers. For example, techniques for spraying washer fluid onto the lens surface to remove the contaminants or using physical wipers to wipe the lens clean are known.

Moreover, vehicles may have a plurality of sensors installed to obtain surrounding situation information during driving. These sensors provide drivers with situation information during driving to assist in safe operation. The sensors include, for example, radar, light detection and ranging (LiDAR), cameras, etc. In particular, such sensors need to be incorporated into autonomous vehicles capable of driving without driver intervention. Recently, a sensor camera is increasingly being adopted as a replacement for expensive radar or LiDAR.

However, conventional devices for cleaning sensor camera lenses have a drawback of being structurally complex, making installation difficult and resulting in low productivity.

### SUMMARY

Provided is a cleaning device for a vehicle sensor camera lens, which has a simple structure, is easy to install, and has superior productivity by improving a structure for cleaning the vehicle sensor camera lens.

Additional aspects will be set forth in part in the description which follows and, in part, will be apparent from the description, or may be learned by practice of the presented embodiments of the disclosure.

According to an aspect of the disclosure, a cleaning device for a vehicle sensor camera lens includes a sensor camera including a lens at an end thereof, a support structure including a lens through hole, through which the lens passes, and supporting the sensor camera, and a fluid passage and a spray nozzle formed on the support structure and supplying a fluid supplied from outside to the lens of the sensor camera.

A hose connection forming a barb-shaped cross-sectional structure may be formed at an inlet of the fluid passage.

An outlet of the fluid passage may form a spray nozzle through which a fluid is sprayed toward the lens.

The fluid passage may be arranged such that a liquid passage for conveying a liquid and a gas passage for conveying air are separated from each other.

An inlet of the liquid passage and an inlet of the gas passage may be arranged parallel to each other.

The support structure may include a camera case including the lens through hole, a routing member coupled to an inner wall of the camera case by fusion bonding and forming the fluid passage, and a camera bracket that is coupled to the sensor camera via a screw and is removably fixed to the camera case.

A receiving groove formed recessed to set a fixing position of the routing member may be provided on the inner wall of the camera case, the routing member may include a convex portion coupled to the receiving groove, and the convex portion may form the fluid passage in a tubular shape in cooperation with the receiving groove.

The camera bracket may include a plurality of fixing holes, and

The fixing hole may be coupled to a fixing projection formed on the camera case.

The camera case may include a catching projection and a mounting hole for fixation to a bumper of a vehicle.

The support structure may include a camera case including the lens through hole and a routing member coupled to an inner wall of the camera case by fusion bonding and forming the fluid passage.

The routing member may include a plurality of installing arms formed as cantilever structures including mounting holes for fixation to a body of the vehicle.

The routing member may include a pair of elastic hooks elastically supporting the sensor camera.

The support structure may include a member forming an exterior skin of a vehicle.

The support structure may include a pillar member including the lens through hole and forming the exterior of the vehicle and a routing member coupled to an inner wall of the pillar member by fusion bonding and forming the fluid passage.

A receiving groove formed recessed to set a fixing position of the routing member may be provided on the inner wall of the pillar member, the routing member may include a convex portion coupled to the receiving groove, and the convex portion may form the fluid passage in a tubular shape in cooperation with the receiving groove.

The routing member may include a ring-shaped ring support surrounding the sensor camera in a circumferential direction.

The pillar member may include a catching projection and a mounting hole for fixation to a bumper of a vehicle.

The support structure may include a fender component member including the lens through hole and a routing member coupled to the inner wall of the pillar member by fusion bonding and forming the fluid passage.

The spray nozzle formed on the routing member may be configured as a hole penetrating both an outer surface and an inner surface of the routing member.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view of a cleaning device for a vehicle sensor camera lens, according to a first embodiment;

FIG. 2 is an exploded perspective view of the cleaning device shown in FIG. 1;

FIG. 3 is a cross-sectional view taken along line III - III shown in FIG. 1;

FIG. 4 is a cross-sectional view taken along line IV - IV shown in FIG. 1;

FIG. 5 is a view showing a position where the cleaning device shown in FIG. 1 is installed on a bumper of a vehicle;

FIG. 6 is a perspective view of a cleaning device for a vehicle sensor camera lens, according to a second embodiment;

FIG. 7 is an exploded perspective view of the cleaning device shown in FIG. 6;

FIG. 8 is a cross-sectional view taken along line VIII - VIII shown in FIG. 6;

FIG. 9 is a view showing a structure of the cleaning device shown in FIG. 6 with a cover nozzle removed therefrom;

FIG. 10 is a view showing a position where the cleaning device shown in FIG. 6 is installed on an external rearview mirror of the vehicle;

FIG. 11 is a perspective view of a cleaning device for a vehicle sensor camera lens, according to a third embodiment;

FIG. 12 is an exploded perspective view of the cleaning device shown in FIG. 11;

FIG. 13 is a cross-sectional view taken along line A - A shown in FIG. 11;

FIG. 14 is a view showing a state where a pillar member is removed from the cleaning device shown in FIG. 11;

FIG. 15 is a view showing a cross-sectional structure taken along line B - B shown in FIG. 14;

FIG. 16 is a view schematically showing a position where the cleaning device shown in FIG. 11 is installed on the vehicle;

FIG. 17 is a perspective view of a cleaning device for a vehicle sensor camera lens, according to a fourth embodiment;

FIG. 18 is an exploded perspective view of the cleaning device shown in FIG. 17;

FIG. 19 is a view showing a structure of the cleaning device shown in FIG. 17 with a fender component member removed therefrom;

FIG. 20 is a cross-sectional view taken along line C - C shown in FIG. 19; and

FIG. 21 is a view showing a position where the cleaning device shown in FIG. 17 is installed on a fender of the vehicle.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

Hereinafter, embodiments will be described in detail with reference to the attached drawings to allow those of ordinary skill in the art to easily carry out the embodiments. However, the disclosure may be implemented in various different forms, and is not limited to the embodiments described herein. In addition, in describing embodiments in detail, when it is determined that a detailed description of a related known function or configuration may unnecessarily obscure the gist of the present disclosure, the detailed description will be omitted. Moreover, the same reference numerals are used for parts having similar functions and actions throughout the drawings.

When a portion is referred to as "includes" a component, the portion may not exclude another component but may further include another component unless stated otherwise. More specifically, it should be understood that the term "include", "have", or the like used herein is to indicate the presence of features, numbers, steps, operations, components, parts, or a combination thereof described in the specifications, and does not preclude the presence or addition of one or more other features, numbers, steps, operations, components, parts, or a combination thereof.

Singular forms include plural forms unless apparently indicated otherwise contextually. In addition, the shapes and sizes of components in the drawings may be exaggerated for the clearer description.

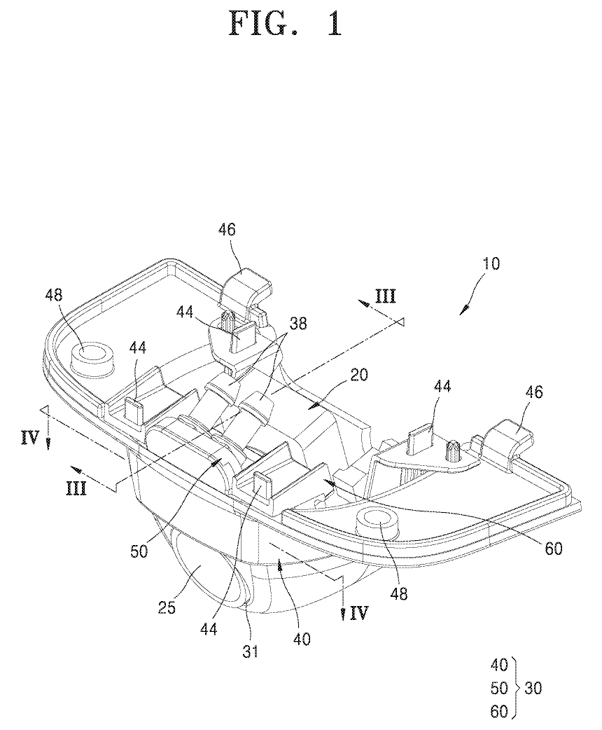

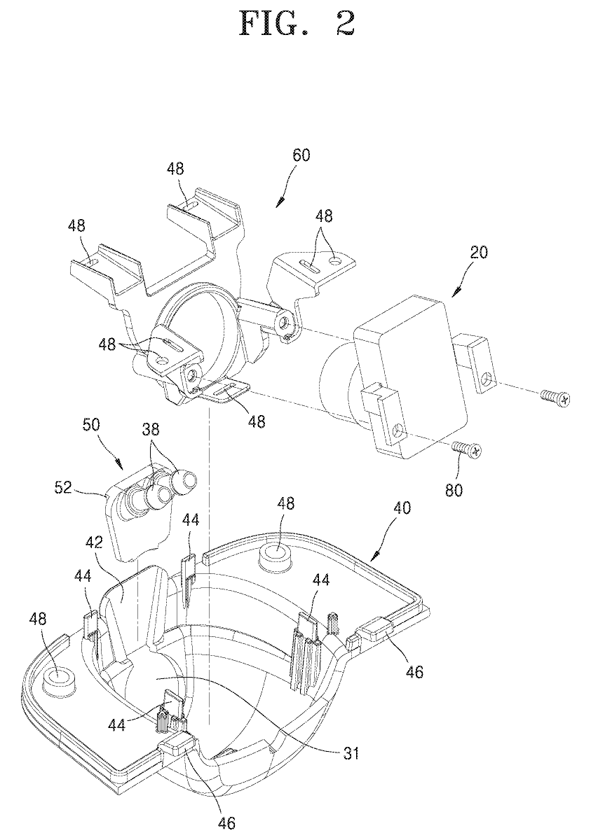

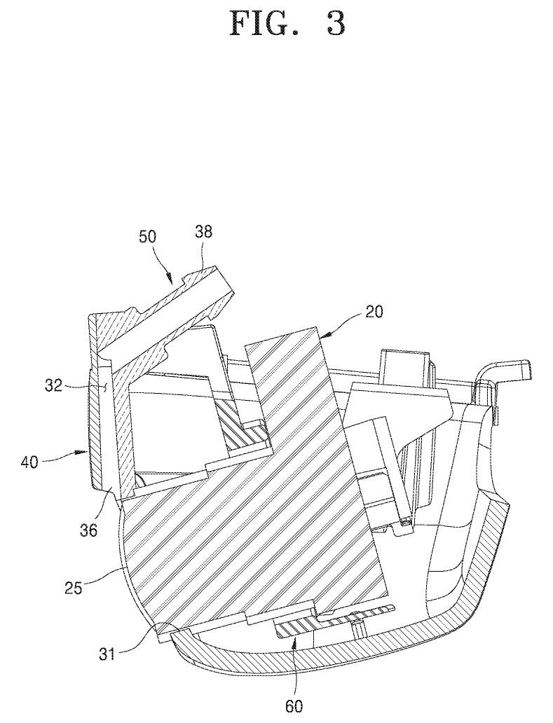

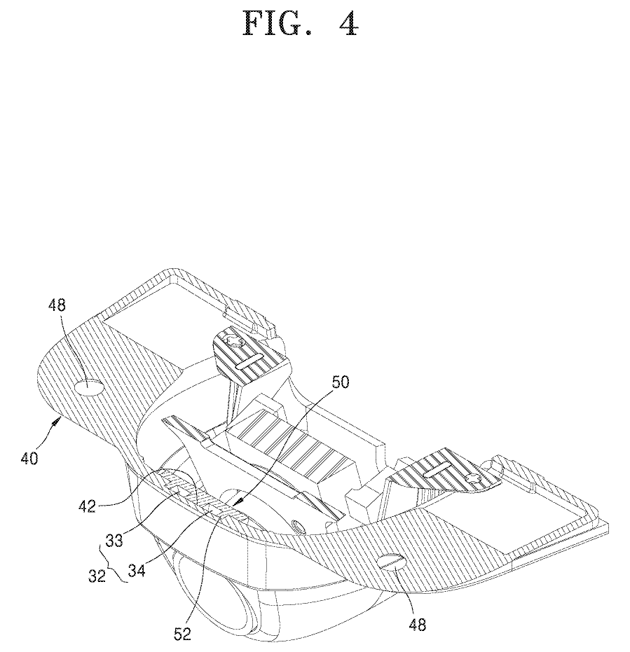

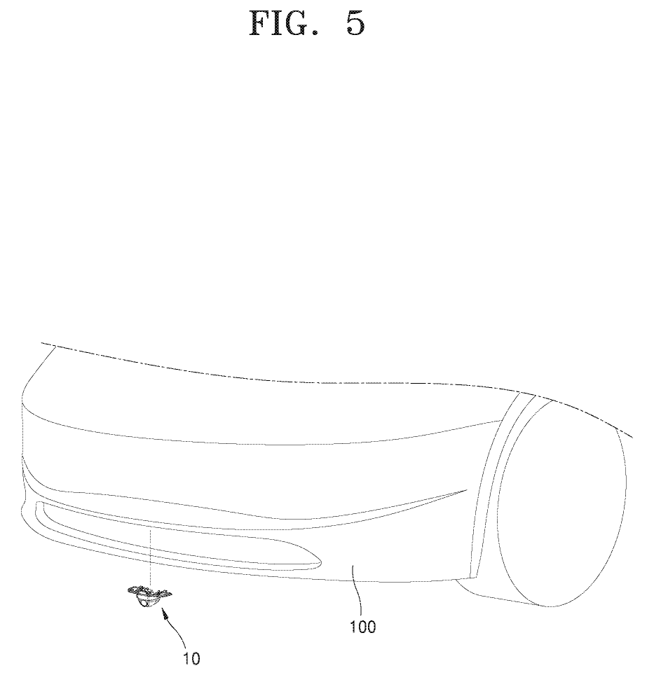

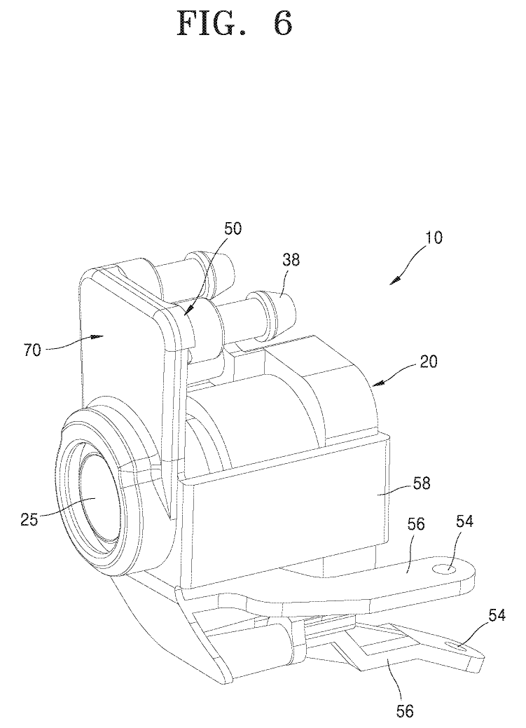

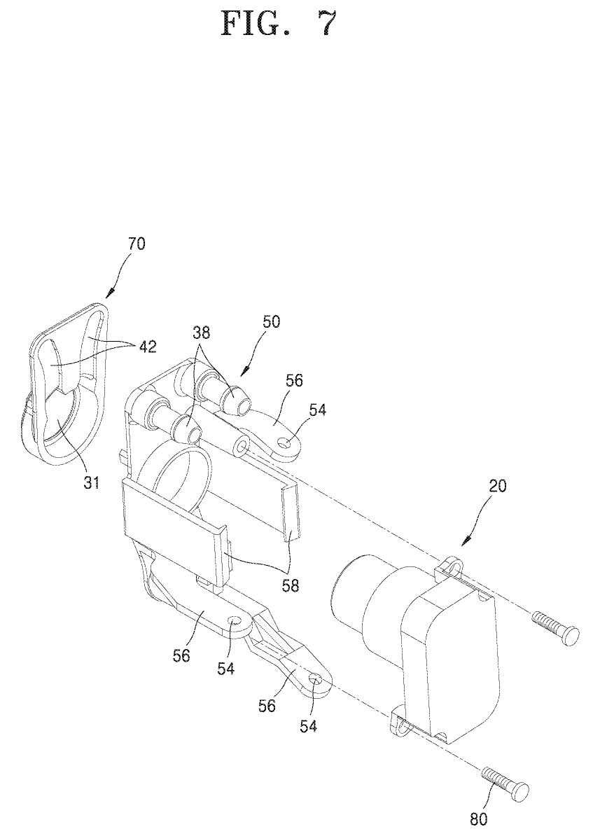

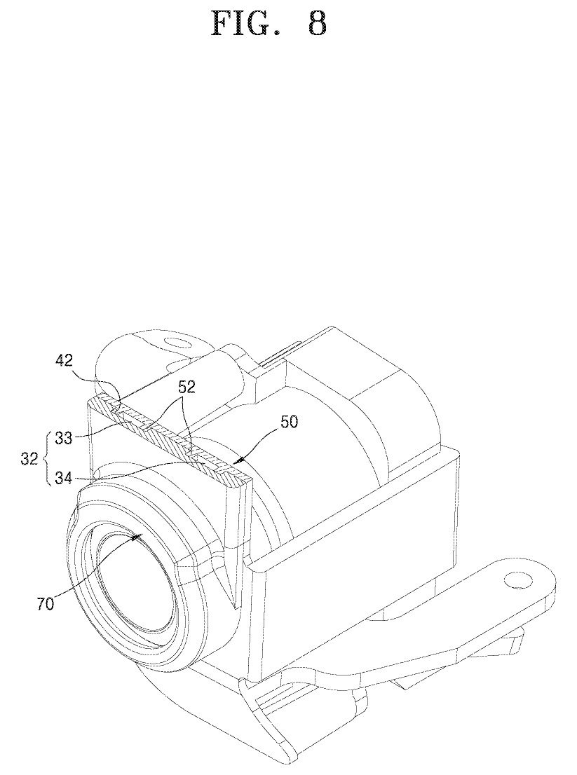

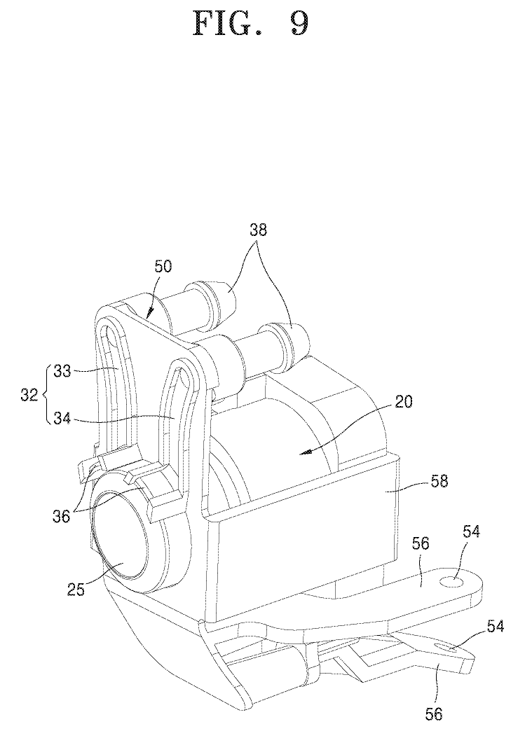

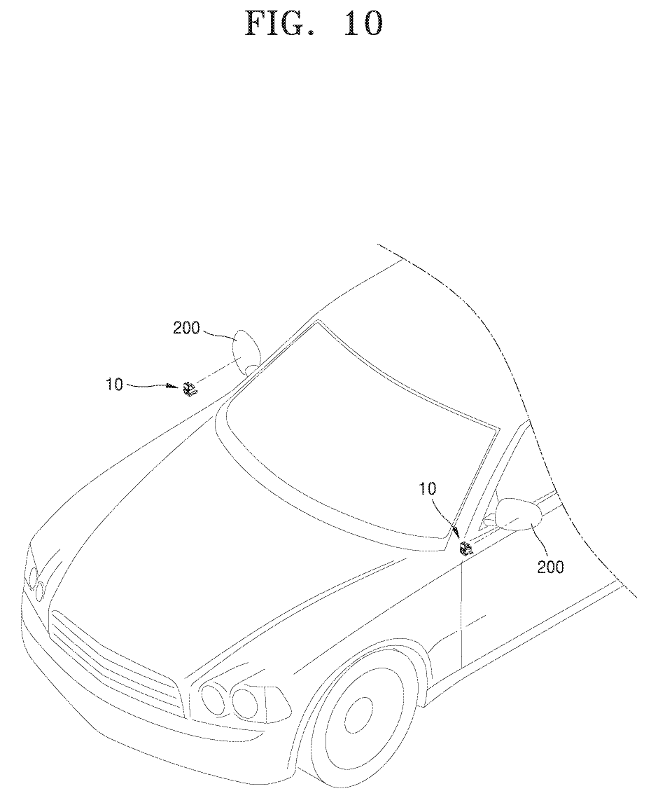

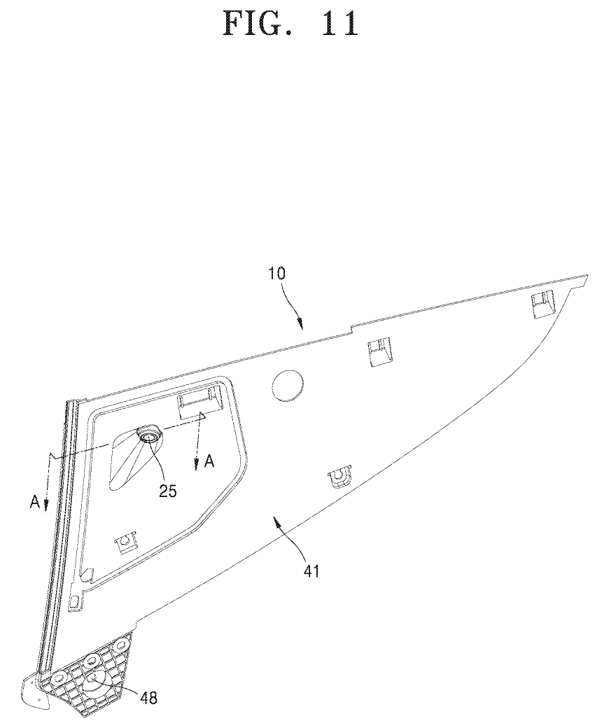

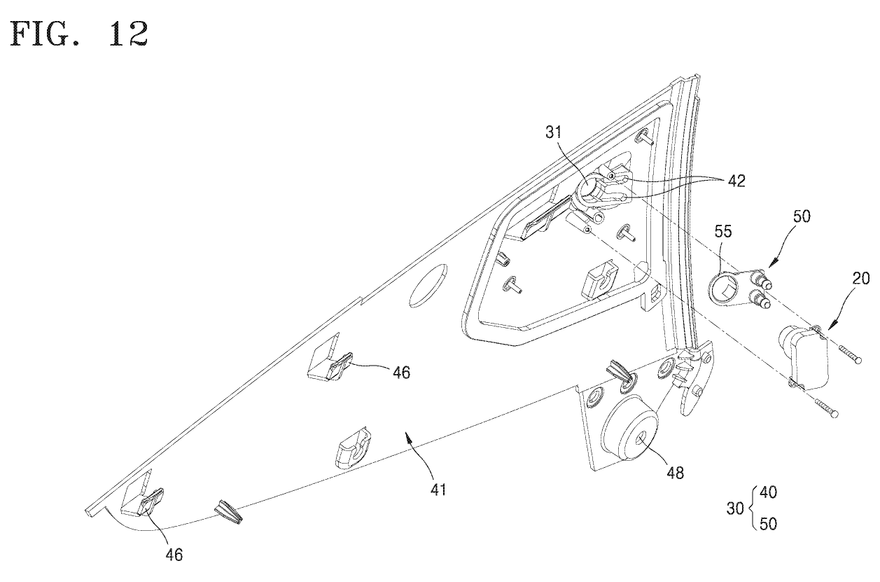

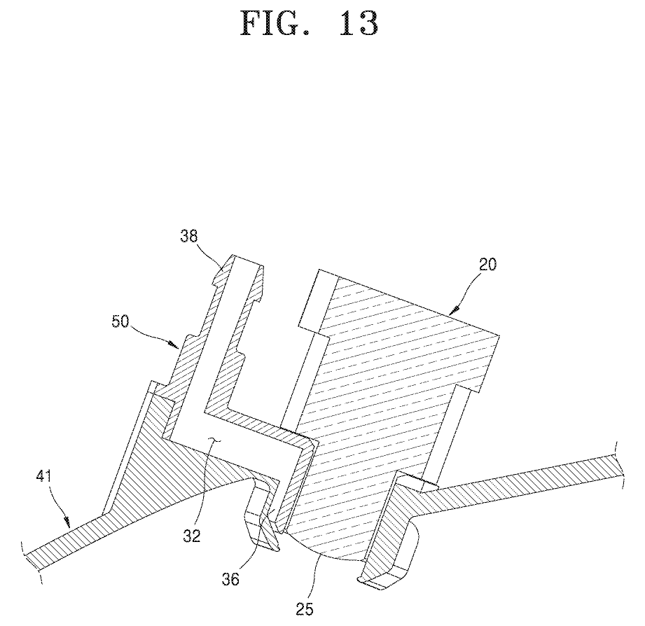

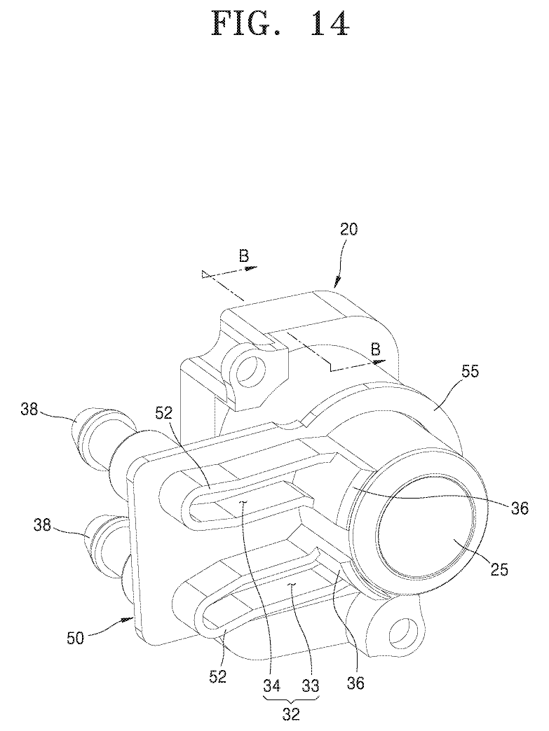

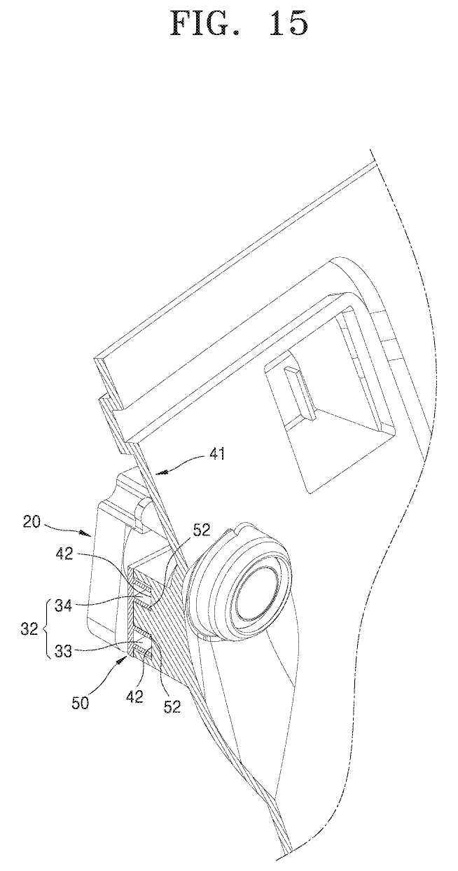

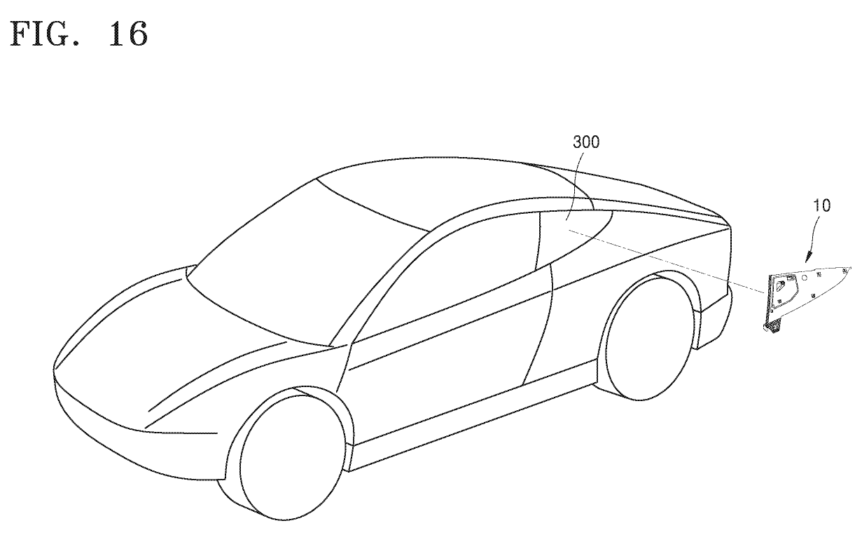

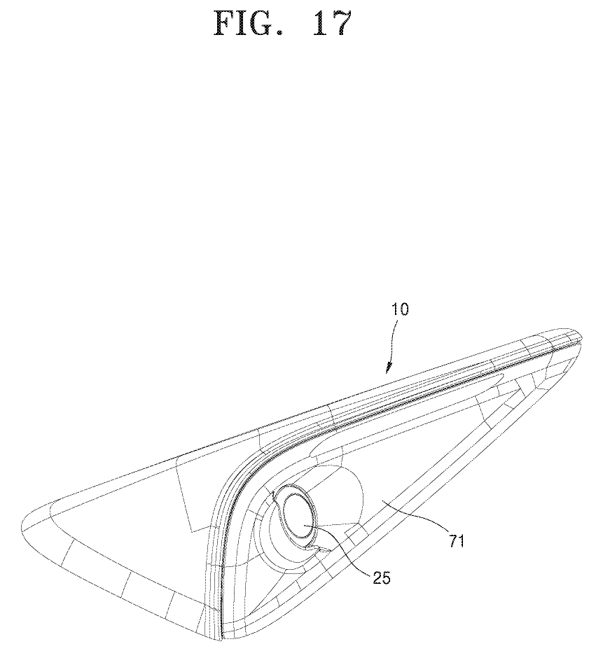

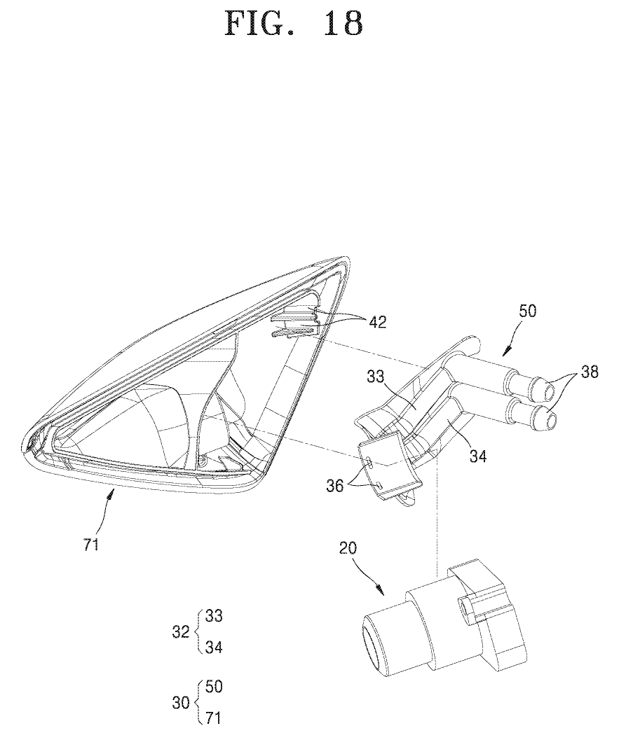

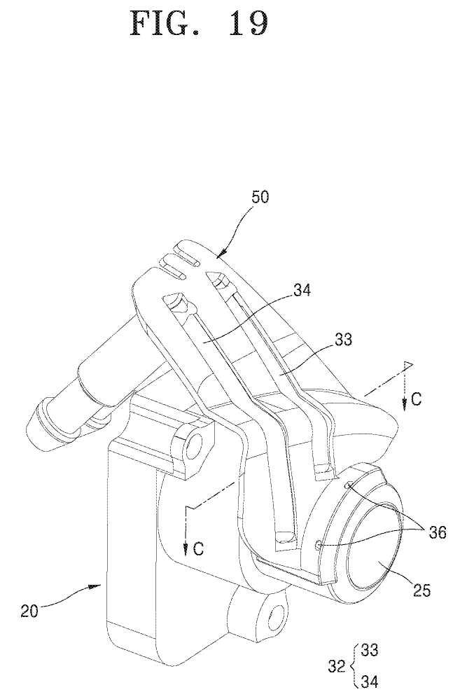

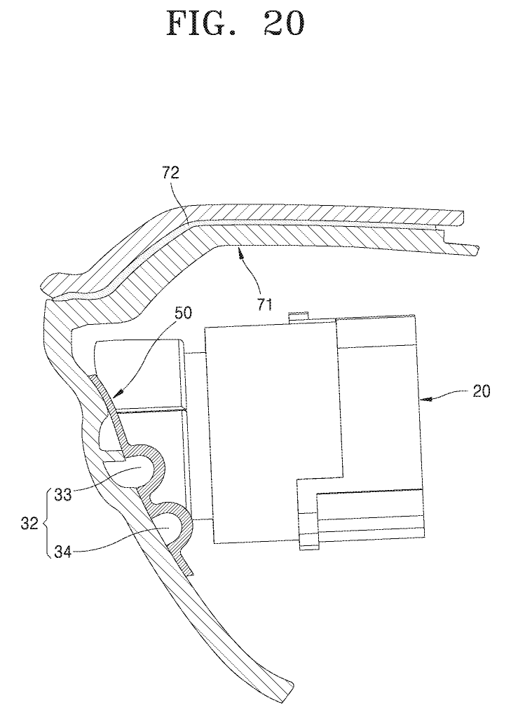

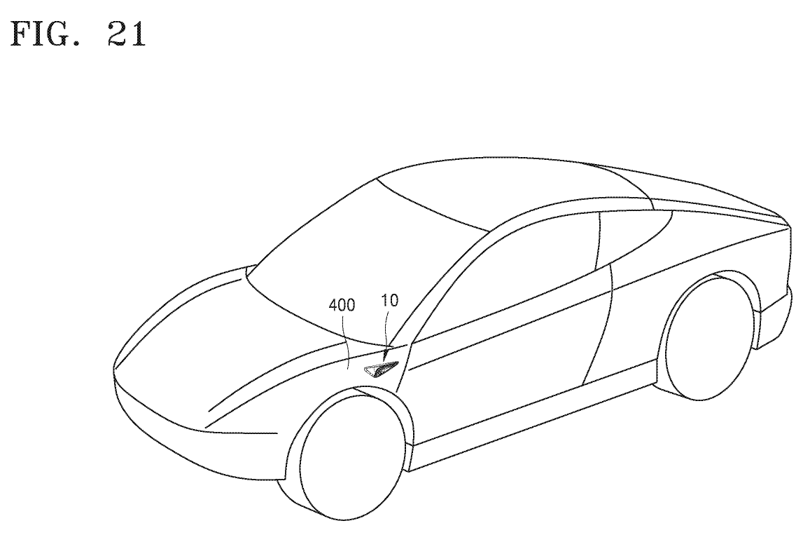

FIG. 1 is a perspective view of a cleaning device for a vehicle sensor camera lens, according to a first embodiment. FIG. 2 is an exploded perspective view of the cleaning device shown in FIG. 1. FIG. 3 is a cross-sectional view taken along line III - III shown in FIG. 1. FIG. 4 is a cross-sectional view cut along a line IV- IV shown in FIG. 1. FIG. 5 is a view showing a position where the cleaning device shown in FIG. 1 is installed on a bumper of a vehicle; FIG. 6 is a perspective view of a cleaning device for a vehicle sensor camera lens, according to a second embodiment. FIG. 7 is an exploded perspective view of the cleaning device shown in FIG. 6. FIG. 8 is a cross-sectional view taken along line VIII - VIII shown in FIG. 6. FIG. 9 is a view showing a structure of the cleaning device shown in FIG. 6 with a cover nozzle removed therefrom. FIG. 10 is a view showing a position where the cleaning device shown in FIG. 6 is installed on an external rearview mirror of the vehicle. FIG. 11 is a perspective view of a cleaning device for a vehicle sensor camera lens, according to a third embodiment. FIG. 12 is an exploded perspective view of the cleaning device shown in FIG. 11. FIG. 13 is a cross-sectional view taken along line A - A shown in FIG. 11. FIG. 14 is a view showing a state where a pillar member is removed from the cleaning device shown in FIG. 11. FIG. 15 is a view showing a cross-sectional structure taken along line B - B shown in FIG. 14. FIG. 16 is a view schematically showing a position where the cleaning device shown in FIG. 11 is installed on the vehicle. FIG. 17 is a perspective view of a cleaning device for a vehicle sensor camera lens, according to a fourth embodiment. FIG. 18 is an exploded perspective view of the cleaning device shown in FIG. 17. FIG. 19 is a view showing a structure of the cleaning device shown in FIG. 17 with a fender component member removed therefrom. FIG. 20 is a cross-sectional view taken along line C - C shown in FIG. 19. FIG. 21 is a view showing a position where the cleaning device shown in FIG. 17 is installed on a fender of the vehicle.

Referring to FIGS. 1 to 21, a cleaning device (hereinafter, referred to as a "cleaning device") 10 for a vehicle sensor camera lens according to the disclosure is a device capable of cleaning a surface of a lens of a sensor camera installed outside the vehicle by sequentially or simultaneously spraying a liquid such as washer fluid and air onto the surface of the lens.

The cleaning device 10 may include a sensor camera 20, a support structure 30, a fluid passage 32, and a spray nozzle 36.

The sensor camera 20 may employ a digital camera. A lens 25 that transmits light may be provided at one end of the sensor camera 20. The light transmitted through the lens 25 into the sensor camera 20 may be converted into electrical signals by a charge-coupled device (CCD) or complementary metal oxide semiconductor (CMOS) corresponding to film in an analog camera, based on the intensity of the light, and may be converted into an image file through a conversion device, an analog-to-digital converter (ADC) that converts an analog signal into a digital signal of 0 and 1 and stored in a memory. The sensor camera 20 may employ a digital camera of a known structure.

The support structure 30 may include a lens through hole 31 through which the lens 25 passes. The support structure 30 may be a member that supports the sensor camera 20. The support structure 30 may be formed by coupling of a plurality of members.

The fluid passage 32 and the spray nozzle 36 may be formed on the support structure 30. The fluid passage 32 and the spray nozzle 36 may serve to supply fluid supplied from outside to the lens 25 of the sensor camera 20.

A hose connection 38 forming a barb-shaped cross-sectional structure may be formed at an inlet of the fluid passage 32. A hose (not shown) for conveying a liquid or gas supplied from an external tank may be connected to the hose connection 38.

An outlet of the fluid passage 32 may form the spray nozzle 36 through which a fluid is sprayed toward the lens 25. The spray nozzle 36 may be configured such that a cross-sectional area of the outlet of the fluid passage 32 is reduced.

The fluid passage 32 may be arranged such that a liquid passage 33 for conveying a liquid and a gas passage 34 for conveying air are separated from each other. The liquid passing through the liquid passage 33 and the air passing through the gas passage 34 may be independently sprayed onto the lens 25 without being mixed with each other.

The liquid sprayed through the liquid passage 33 and the air sprayed through the gas passage 34 may be simultaneously sprayed onto the surface of the lens 25. Depending on a need, the liquid sprayed through the liquid passage 33 and the air sprayed through the gas passage 34 may be sequentially sprayed onto the surface of the lens 25. The liquid sprayed through the liquid passage 33 may be effective in removing foreign substances from the lens 25. The air sprayed through the gas passage 34 may further serve to dry the surface of the lens 25 after removal of foreign substances from the lens 25. By arranging the liquid passage 33 and the gas passage 34 to be separated from each other, residual liquid may be effectively prevented from being sprayed during air injection.

The liquid sprayed onto the lens 25 through the liquid passage 33 may employ a known washer fluid.

The inlet of the liquid passage 33 and the inlet of the gas passage 34 may be arranged parallel to each other.

In the first embodiment shown in FIGS. 1 through 5, the support structure 30 may include a camera case 40, a routing member 50, and a camera bracket 60.

The camera case 40 may be provided with a lens through hole 31. The camera case 40 may be formed with a structure having a space to accommodate the sensor camera 20 therein. A top portion of the camera case 40 may be open. The camera case 40 may be manufactured with synthetic resin.

A routing member 50 may be bonded to an inner wall of the camera case 40 by fusion bonding. The routing member 50 may be coupled to the camera case 40, for example, by ultrasonic welding. The hose connection 38 may be integrally formed on the routing member 50. The fluid passage 32 communicating with the hose connection 38 may be formed on the routing member 50. The cross-sectional area of the fluid passage 32 gradually decreases toward the outlet, forming the smallest cross-sectional area at the outlet to constitute the spray nozzle 36. The routing member 50 may be manufactured with synthetic resin. A distance between the liquid passage 33 and the gas passage 34 that constitutes the fluid passage 32 may be arranged to decrease toward the outlet.

The camera bracket 60 may be coupled to the sensor camera 20 via a screw 80. The camera bracket 60 may be detachably secured to the camera case 40. The camera bracket 60 may serve to more securely fix the sensor camera 20 to the camera case 40. The camera bracket 60 may be manufactured with synthetic resin.

An inner wall of the camera case 40 may include a receiving groove 42 formed recessed to set a fixed position of the routing member 50.

The routing member 50 may include a convex portion 52 coupled to the receiving groove 42. The convex portion 52 may cooperate with the receiving groove 42 to form the fluid passage 32 in a tubular shape. The fluid passage 32 formed in the convex portion 52 may have an open surface facing the receiving groove 42. The fluid passage 32 formed in the convex portion 52 may be coupled to the receiving groove 42 to form a tubular passage. The outlet of the fluid passage 32 may form the spray nozzle 36.

The camera bracket 60 may include a plurality of fixing holes 62. The fixing holes 62 may be positioned spaced apart from each other. The fixing holes 62 may be slot-shaped holes. The fixing holes 62 may be coupled to fixing projections 44 formed on the camera case 40.

The camera case 40 may include a catching projection 46 and a mounting hole 48 for fixation to a bumper 100 of the vehicle. A pair of catching projections 46 may be provided. A pair of mounting holes 48 may be provided.

Meanwhile, in the second embodiment shown in FIGS. 6 to 10, the support structure 30 may include a cover nozzle 70 and the routing member 50.

The cover nozzle 70 may be a structure having the lens through hole 31. The lens through hole 31 may be provided in the lower portion of the cover nozzle 70. A top portion of the cover nozzle 70 may form a plate-shape structure. The cover nozzle 70 may be manufactured with synthetic resin.

The routing member 50 may be bonded to an inner wall of the cover nozzle 70 by fusion bonding. The routing member 50 may be coupled to the cover nozzle 70, for example, by ultrasonic welding. The hose connection 38 may be integrally formed on the routing member 50. The fluid passage 32 communicating with the hose connection 38 may be formed on the routing member 50.

The routing member 50 may include a plurality of installing arms 56 formed as cantilever structures including assembling holes 54 for fixation to a body of the vehicle. Each of the installing arms 56 may be provided with the assembling hole 54. The installing arm 56 may be formed extending away from the lens through hole 31. The installing arm 56 and the assembling hole 54 may be used to install the cleaning device 10 onto an external rearview mirror 200 of the vehicle as shown in FIG. 10.

The routing member 50 may be removably coupled to the sensor camera 20 via the screw 80.

The routing member 50 may include a pair of elastic hooks 58. The elastic hook 58 may be configured to elastically support the sensor camera 20. The elastic hook 58 may be symmetrically arranged to elastically support opposite sides of the sensor camera 20. The elastic hook 58 may serve to prevent the sensor camera 20 from deviating from the rear of the routing member 50.

In the third embodiment shown in FIGS. 11 to 16, the support structure 30 may include a pillar member 41 and the routing member 50.

The pillar member 41 may include the lens through hole 31. The pillar member 41 may be formed with a structure having a space to accommodate the sensor camera 20 therein. The pillar member 41 may, for example, form a B-pillar that constitutes the exterior skin of the vehicle. The pillar member 41 may be manufactured with synthetic resin.

The routing member 50 may be bonded to an inner wall of the pillar member 41 by fusion bonding. The routing member 50 may be coupled to the pillar member 41, for example, by ultrasonic welding. The hose connection 38 may be integrally formed on the routing member 50. The fluid passage 32 communicating with the hose connection 38 may be formed on the routing member 50. The cross-sectional area of the fluid passage 32 may form the smallest cross-sectional area at the outlet to form the spray nozzle 36. The routing member 50 may be manufactured with synthetic resin.

An inner wall of the pillar member 41 may include a receiving groove 42 formed recessed to set the fixed position of the routing member 50.

The routing member 50 may include the convex portion 52 coupled to the receiving groove 42. The convex portion 52 may form the fluid passage 32 in a tubular shape in cooperation with the receiving groove 42. The fluid passage 32 formed in the convex portion 52 may have an open surface facing the receiving groove 42. The fluid passage 32 formed in the convex portion 52 may be coupled to the receiving groove 42 to form a tubular passage. The outlet of the fluid passage 32 may form the spray nozzle 36.

The pillar member 41 may include the catching projection 46 and the mounting hole 48 for fixation to a B-pillar 300 that forms the body of the vehicle. A plurality of catching projections 46 may be provided.

Meanwhile, in the fourth embodiment shown in FIGS. 17 to 21, the support structure 30 may include a fender component member 71 and the routing member 50.

The fender component member 71 may be a structure having the lens through hole 31. The fender component member 71 may be attached to a fender 400 that forms the exterior skin of the vehicle. The fender component member 71 may be manufactured with synthetic resin. The fender component member 71 may be formed by coupling of a plurality of members. In case that the fender component member 71 is stacked as a plurality of fender component members 71, a cushioning material 72 may be installed in a space between the fender component members 71 to prevent contact friction between the fender component members 71.

The routing member 50 may be bonded to an inner wall of the fender component member 71 by fusion bonding. The routing member 50 may be coupled to the fender component member 71, for example, by ultrasonic welding. The hose connection 38 may be integrally formed on the routing member 50. The fluid passage 32 communicating with the hose connection 38 may be formed on the routing member 50.

The routing member 50 may include a ring-shaped ring support 55 that surrounds and supports an outer circumferential surface of the sensor camera 20 in a circumferential direction.

The spray nozzle 36 formed on the routing member 50 may be configured as a hole penetrating both an outer surface and an inner surface of the routing member 50.

As described above, the cleaning device for the vehicle sensor camera lens according to the disclosure may provide a simplified structure, easy installation, and improved productivity, by integrally forming the fluid passage and the spray nozzle for conveying and spraying a fluid that performs cleaning onto the routing member that constitutes the support structure supporting the camera sensor and thus removing a need to form a separate fluid conveying structure.

Furthermore, as in the embodiment, the fluid passage formed on the routing member may form the tubular passage with the camera case or cover nozzle coupled by fusion bonding, thereby facilitating manufacturing and further enhancing productivity.

Furthermore, as in the embodiment, the fluid passage formed on the routing member may form the tubular passage with the pillar member or fender component member coupled by fusion bonding, thereby facilitating manufacturing and further enhancing productivity.

While the disclosure is described by limited embodiments and drawings, the disclosure is not limited thereby and various modifications and changes may be made by those of ordinary skill in the art within the technical spirit of the disclosure and the equivalent range to the claims set forth below.

The cleaning device for the vehicle sensor camera lens according to the disclosure may provide a simplified structure, easy installation, and improved productivity, by including the fluid passage and the spray nozzle that are installed on the support structure including the lens through hole, through which the lens of the sensor camera passes, so as to supply a fluid supplied from the outside to the lens of the sensor camera, and thus removing a need to separately include a fluid supply path and a nozzle for cleaning the lens.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A cleaning device for a vehicle sensor camera lens, the cleaning device comprising:
a sensor camera comprising a lens at an end thereof;
a support structure comprising a lens through hole, through which the lens passes, and supporting the sensor camera; and
a fluid passage and a spray nozzle formed on the support structure and supplying a fluid supplied from outside to the lens of the sensor camera,
wherein the support structure comprises a camera case comprising the lens through hole and a routing member coupled to an inner wall of the camera case by fusion bonding and forming the fluid passage, and
a receiving groove formed recessed to set a fixing position of the routing member is provided on the inner wall of the camera case, the routing member comprises a convex portion coupled to the receiving groove, and the convex portion forms the fluid passage in a tubular shape in cooperation with the receiving groove.

2. The cleaning device of claim 1, wherein a hose connection is formed to have a structure with a barb-shaped cross-section at an inlet of the fluid passage.

3. The cleaning device of claim 1, wherein an outlet of the fluid passage forms a spray nozzle through which a fluid is sprayed toward the lens.

4. The cleaning device of claim 1, wherein the fluid passage is arranged such that a liquid passage for conveying a liquid and a gas passage for conveying air are separated from each other.

5. The cleaning device of claim 4, wherein an inlet of the liquid passage and an inlet of the gas passage are arranged parallel to each other.

6. The cleaning device of claim 1, wherein the support structure comprises a camera bracket that is coupled to the sensor camera via a screw and is removably fixed to the camera case.

7. The cleaning device of claim 6, wherein the camera bracket comprises a plurality of fixing holes, and
each fixing hole is coupled to a fixing projection formed on the camera case.

8. The cleaning device of claim 6, wherein the camera case comprises a catching projection and a mounting hole for fixation to a bumper of a vehicle.

9. A cleaning device for a vehicle sensor camera lens, the cleaning device comprising:
a sensor camera comprising a lens at an end thereof;
a support structure comprising a lens through hole, through which the lens passes, and supporting the sensor camera; and
a fluid passage and a spray nozzle formed on the support structure and supplying a fluid supplied from outside to the lens of the sensor camera,
wherein the support structure comprises a cover nozzle comprising the lens through hole and a routing member coupled to an inner wall of the cover nozzle by fusion bonding and forming the fluid passage,
the support structure comprises a member forming an exterior skin of a vehicle, and
the support structure comprises a pillar member comprising the lens through hole and forming a part of the exterior of the vehicle and a routing member coupled to an inner wall of the pillar member by fusion bonding and forming the fluid passage.

10. The cleaning device of claim 9, wherein the routing member comprises a plurality of installing arms formed as cantilever structures to have assembling holes for fixation to a body of the vehicle.

11. The cleaning device of claim 9, wherein the routing member comprises a pair of elastic hooks elastically supporting the sensor camera.

12. The cleaning device of claim 9, wherein a receiving groove formed recessed to set a fixing position of the routing member is provided on the inner wall of the pillar member, the routing member comprises a convex portion coupled to the receiving groove, and the convex portion forms the fluid passage in a tubular shape in cooperation with the receiving groove.

13. The cleaning device of claim 9, wherein the routing member comprises a ring-shaped ring support surrounding the sensor camera in a circumferential direction.

14. The cleaning device of claim 9, wherein the pillar member comprises a catching projection and a mounting hole for fixation to a bumper of a vehicle.

15. The cleaning device of claim 9, wherein the support structure comprises a fender component member comprising the lens through hole and a routing member coupled to the inner wall of the pillar member by fusion bonding and forming the fluid passage.

16. The cleaning device of claim 15, wherein the spray nozzle formed on the routing member is configured as a hole penetrating both an outer surface and an inner surface of the routing member.
